(19) United States
(12) Patent Application Publication
(10) Pub. No.: US 2012/0324787 A1
(43) Pub. Date: Dec. 27, 2012

(54) APPARATUS AND METHOD FOR CULTIVATING ONE OR MORE PLANTS

(75) Inventors: Kamal DAAS, Bergschenhoek (NL); Talal DAAS, Naperville, IL (US); Peter VAN DER DRIFT, Bleiswijk (NL)

(73) Assignee: HORTICOOP B.V., Bleiswijk (NL)

(21) Appl. No.: 13/439,264

(22) Filed: Apr. 4, 2012

(30) Foreign Application Priority Data
Apr. 6, 2011 (DE) 20 2011 004 908.6

(51) Int. Cl. A01G 9/02

(52) U.S. Cl. 47/65.8; 47/86; 47/65.7; 47/79; 47/66.7

(57) ABSTRACT

The present invention relates to an apparatus for cultivating one or more plants, wherein the apparatus has at least one first chamber and at least one second chamber which are separated from one another by at least one first partition wall, wherein the inner spaces of the first and second chambers communicate by one or more communication openings in the first partition wall, and wherein the apparatus has at least one adjustment device which is arranged and designed so that a change in the position and/or a change in the shape of the first partition wall takes place on an actuation of the adjustment device.

The invention relates to an apparatus for cultivating one or more plants as well as to a method for cultivating one or more plants.

Apparatus and methods for the commercial cultivation of plants, in particular crop plants, are known in the prior art.

It is a goal of the invention to provide an apparatus which allows an improved cultivation of plants and in particular of crop plants bearing a crop.

This object is achieved by an apparatus having the features of claim 1.

Provision is accordingly made that the apparatus has at least one first and at least one second chamber which are separated from one another by at least one first partition wall, wherein the inner spaces of the first and second chambers communicate by one or more communication openings in the first partition wall, and wherein at least one adjustment device is provided which is arranged and designed so that a change in the position and/or a change in the shape of the first partition wall takes place on an actuation of the adjustment device. It is thus possible by means of the adjustment device to change the position of the first partition wall and/or the shape of the first partition wall.

In this respect, the adjustment device can be arranged and designed such that on their actuation, the first partition wall is moved such that the size of the first chamber and/or of the second chamber is changed. It is also conceivable and covered by the invention that the adjustment device is arranged and designed such that on its actuation, the first partition wall undergoes a change in its shape, for example from a straight arrangement into an angled arrangement or the like.

It is conceivable that the adjustment device is arranged and designed so that on its actuation, only the position (and not the shape) or only the shape (and not the position) or both the shape and the position of the first partition wall is/are changed.

It is furthermore conceivable that the adjustment device is designed so that the shape is changeable independently of the position of the first partition wall.

It is possible by the design of the apparatus in accordance with the invention to take the fact into account that the space requirements of a plant or in particular of a crop plant change over the course of time.

If, for example, crop is formed, such as potatoes or the like, provision can be made that the corresponding chamber is enlarged by the movably designed partition wall so that the space available for the crop becomes larger and the crop yield increases overall. Provision can also be made that the inclination of the first partition wall can be changed, which is possible by a position change and/or a shape change. Such a change in the inclination can take place for the purpose of causing the crop to spread in a suitable manner or to adopt a specific position in the chamber in which it is located.

The change in position can, for example, be a movement of the partition wall in part or in full, for example by pivoting, displacing, relocating, etc. A movement of the partition wall can, however, also be achieved in that the partition wall is flexible and in particular yielding or elastically or plastically deformable and thereby optionally enables a volume change of the adjacent chambers and/or a change in the shape of the chambers.

The first partition wall can be designed as rigid region-wise and as flexible region-wise.

The adjustment device can be in direct connection with the first partition wall. An indirection connection, for example via a connection element, etc., is, however, also conceivable and covered by the invention.

In a further embodiment of the invention, the adjustment device is designed such that on its actuation, the first partition wall is moved so that the size of the first chamber and/or of the second chamber changes due to the movement of the first partition wall. It is possible that the apparatus is designed so that on the movement of the first partition wall, the volume of the second chamber admittedly changes, but not that of the first chamber.

Provision is made in a further embodiment of the invention that the first partition wall is arranged or formed such that it is pivotable or bendable or movable in another manner.

It is furthermore conceivable that the adjustment device has a first adjustment mechanism which is directly or indirectly connected to the first partition wall such that on an actuation of the first adjustment mechanism, the position of the first partition wall changes.

The named first adjustment mechanism can have a first bar, preferably a threaded bar or the like which is directly or indirectly connected to the first partition wall. This bar can, for example, be movable in a translation movement in the direction into the second chamber and/or movable in the direction out of the second chamber.

The first adjustment mechanism can have an actuation element, preferably an actuation element with an internal thread, such as a hand wheel or the like which is connected to the first bar such that on a rotation of the actuating element, a movement in translation of the first bar takes place. The bar can thus be moved in the one or the other direction by the rotation of the actuating element in dependence on the direction of rotation of the actuating element and movement of the first partition wall can thus be brought about.

The first partition wall can be designed as deformable section-wise or in full. It is conceivable that the first partition wall has rigid sections, for example made of steel or the like, which are connected to one another by a deformable element, for example made of plastic or rubber.

The first partition wall preferably has at least two sections whose angle toward one another can be changed. This change in the angle can be caused by the adjustment device. It is thus conceivable, for example, that the two sections of the partition wall have a larger angle toward one another at an early stage of the plant growing than at a late stage of the plant growing. It is thus conceivable for the angle between the sections to be reduced or for the inclination of the sections relative to the horizontal to be increased if fruits have already formed to move them in a specific direction or into a specific region of the apparatus.

The adjustment device can have a second adjustment mechanism which is directly or indirectly connected to the first partition wall such that on an actuation of the second adjustment mechanism, the shape of the first partition wall changes. In this respect, it is conceivable that the second adjustment mechanism has a second bar, preferably a threaded bar or the like, which is directly or indirectly connected to the first partition wall. In this respect, the second bar is connected to the first partition wall such that on a movement of the second bar, the shape of the first partition wall changes.

The second adjustment mechanism can have an actuation element, preferably an actuation element with an internal thread which is connected to the second bar such that on a rotation of the actuating element, a movement in translation of the second bar takes place.

The second adjustment mechanism can have at least one lever mechanism.

It is conceivable that the lever mechanism has at least one first lever which is directly or indirectly connected to the second bar and/or at least one second lever which is directly or indirectly connected to the first partition wall, with provision preferably being made that the first lever is pivotably connected to the second lever; and/or in that the second lever is pivotably connected to the first partition wall.

In a particularly preferred embodiment of the invention, the first adjustment mechanism can be actuated independently of the second adjustment mechanism, i.e. the user can effect a change in the position or a change in the shape of the first partition wall. It is also conceivable that the two adjustment mechanisms are coupled to one another such that an actuation of the one adjustment mechanism therefore necessarily results in an actuation of the other adjustment mechanism.

An apparatus having a particularly simple and space-saving design can be achieved in that the first bar is hollow and in that the second bar runs in the hollow space of the first bar.

It is particularly advantageous if the adjustment apparatus is arranged such that its actuation outside the first and second chambers is possible. A particularly comfortable use results when the adjustment device can be actuated by a user without opening the chambers.

Provision is made in a further embodiment of the invention that the second chamber has one or more outlet openings which are arranged in at least one second partition wall which bounds the second chamber at least regionally, preferably at its upper side. This second partition wall can thus, for example, form an upper cover of the apparatus. It is conceivable that a stem or the like of the plant projects through these outlet openings and that the leaves of the plant form or are located above the outlet opening, i.e. above the second partition wall, and the crop beneath the second partition wall. It is further conceivable that the root region of the plant is located in the first chamber which is separated at least partly by the first partition wall.

Provision is made in a further embodiment of the invention that the apparatus has at least one first wall, preferably a side wall and/or a wall at the base side, which comprises a flexible material and/or whose height and/or length and/or width is variable.

This first wall can form a boundary of the second chamber.

The apparatus can furthermore have at least one second wall, preferably side wall, which forms a boundary of the first chamber. It can also comprise a flexible material and/or its height and/or length and/or width can be variable.

The first wall and/or the second wall can be flexible and/or elastic. They preferably consist of or comprise plastic.

Provision can furthermore be made that the first wall and the second wall are directly or indirectly connected to one another.

It is conceivable that at least one connection element is provided which connects the first wall to the second wall. This connection element can comprise a metal, for example, preferably steel.

The connection element and/or the first partition wall can have at least one receiver in which a region of the first wall and/or a region of the second wall is received, wherein provision is preferably made that at least one element is arranged in the at least one receiver which fixes the region of the first wall and/or of the second wall in the receiver.

It is generally conceivable that the first wall and/or the second wall is rolled up or is otherwise received in multi-layers or the like in the receiver regions so that a change in the dimension or in the height and/or length and/or the width of the walls can be obtained by corresponding rolling off. This can apply to the receiver(s) in the first partition wall and/or in the second partition wall and/or in the connection element. This applies independently of whether the named element is arranged in the receivers or not. If such an element is arranged, it can serve not only to fix the wall, but also for the purpose that the wall is wound up onto the element or can be unwound from or wound onto it in its corresponding region.

This element can, for example, be designed as an inlay which holds a section of the first wall and/or of the second wall in the respective receiver. It is conceivable to make this inlay from metal, for example from steel. The marginal region of the first wall and/or of the second wall can be wound once or a multiple of times around this element, whereby a particularly reliable fixing of the corresponding regions of the wall in the receivers results.

Provision can furthermore be made that the second partition wall has at least one receiver in which a region of the second wall is received, with provision preferably being made that at least one element is arranged in the at least one receiver which fixes the region of the second wall in the receiver. It is conceivable that the second wall is rolled up in this receiver or can be rolled up and/or unrolled or is otherwise arranged in multiple layers so that the height and/or the length and/or the width of the wall can be changed.

This first and/or second side wall can form a or the side outer walls as well as the base wall of the apparatus.

It is conceivable to form this first wall and/or second wall from a film or from a band or fabric or from any other material, preferably made from plastic, which can be rolled up or wound up.

Provision is made in a further embodiment of the invention that at least one plant is arranged in the apparatus such that the roots of the plant are located exclusively or predominantly in the first chamber and the region of the plant bearing the crop is located exclusively or predominantly in the second chamber.

Provision can furthermore be made that at least one plant is arranged in the apparatus such that a container or anther holder for fixing the plant is located in the at least one communication opening of the first partition wall. Soil or another substrate can be arranged in this container or holder, for example. Provision is preferably made that the roots extend in one direction and a stem or a region of the plant bearing the crop extends in the other direction from the container or holder.

Provision is made in a further embodiment of the invention that at least one plant is arranged in the apparatus such that the stem of the plant extends through the at least one outlet opening of the second partition wall and the leaves of the plant are located at least in part above the second partition wall and outside the second chamber.

A further cover such as a glass cover or plastic cover which is permeable to light can then preferably be provided as required above this second partition wall. The adjustment mechanism can be arranged such that its actuation is possible without removing this cover or such that the cover has to be removed to be able to carry out an actuation.

It is generally conceivable that the adjustment device is actuated partly or completely manually or in a driven manner, e.g. driven by a motor.

Provision can furthermore be made that water and/or nutrients are present in the first and/or second chamber(s) and/or that means are provided such as pipelines, hoses or nozzles or the like by means of which the first and/or the second chamber(s) can be supplied with water and/or nutrients.

The second chamber, which preferably serves the reception of the crop region or of the crop of the plant, can extend at least regionally above and/or next to the first chamber.

Provision is made in a further embodiment of the invention that the apparatus has an elongate extension. It should be understood by this that the apparatus is made larger in a first dimension, i.e. in the longitudinal direction, than in the other directions, i.e. than in the width direction and vertical direction.

The present invention furthermore relates to an arrangement including a plurality of apparatus for cultivating one or more plants, in particular in accordance with one of the claims 1 to 30, wherein the apparatus are preferably arranged so that their spacing from one another is changeable. This embodiment of the invention has the advantage that the harvester or another user has the possibility of moving two apparatus away from one another to be able to move into the space between the two apparatus and to carry out the measures required such as harvesting or a treatment of the plant or the like. Subsequently the user can move the apparatus together again.

These movements can take place manually or mechanically or in an automated manner, e.g. by means of a motor.

It is conceivable that apparatus are arranged next to one another, and indeed such that the spacing of the side walls of two adjacent apparatus with respect to one another can be increased and reduced. It is thus conceivable, for example, that every individual apparatus comprises an elongate element and that these elongate elements are arranged parallel, or substantially parallel, to one another, wherein the spacing of at least two of these elements or apparatus from one another can be enlarged and/or reduced.

Provision can furthermore be made that the apparatus are connected to a suspension, wherein the suspension is designed so that the spacing of the apparatus or of the rows from one another is changeable and/or that the apparatus are connected to a support structure, in particular to rollers, rails, guides or the like, which are designed such that the spacing of the apparatus or of the rows from one another is changeable.

The present invention furthermore relates to a method of cultivating one or more plants in an apparatus in accordance with one of the claims 1 to 30 or in an arrangement in accordance with one of the claims 31 to 33 comprising the step-wise or continuous enlargement of the volume of the second chamber.

It is conceivable that the enlargement of the volume of the second chamber takes place by changing the position and/or shape of the first partition wall, with this change being able to be achieved by the adjustment mechanism.

The present invention finally relates to a method of harvesting the crop of one or more plants in an apparatus in accordance with one of the claims 1 to 30 or in an arrangement in accordance with one of the claims 31 to 33 comprising the step of the at least sectional pivoting, displacing, opening or removing of at least one boundary surface of the second chamber and the removal of the crop from the second chamber, wherein this step is preferably preceded by the enlargement of the spacing of at least two adjacent apparatus.

Further details and advantages of the invention will be explained in more detail with reference to an embodiment shown in the drawing.

There are shown:

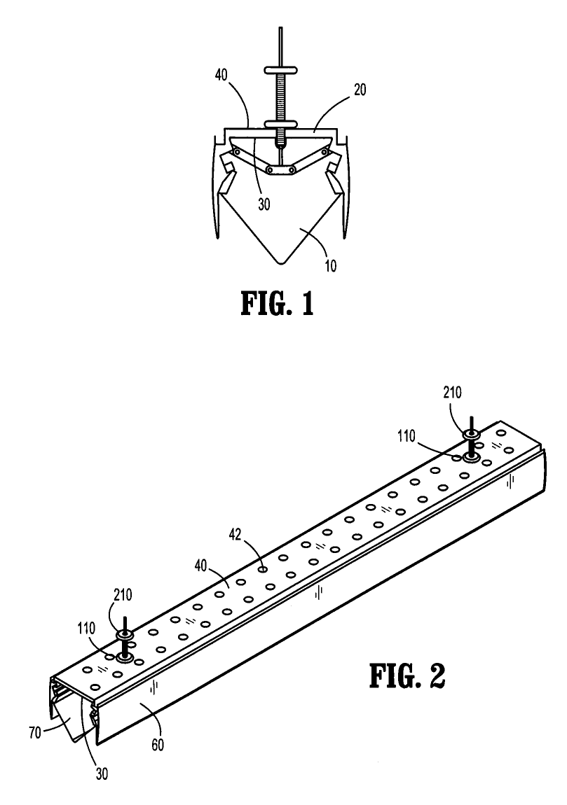

FIG. 1: a cross-sectional view of the apparatus in accordance with the invention in a first position/shape of the first partition wall;

FIG. 2: a perspective representation of the apparatus in accordance with FIG. 1;

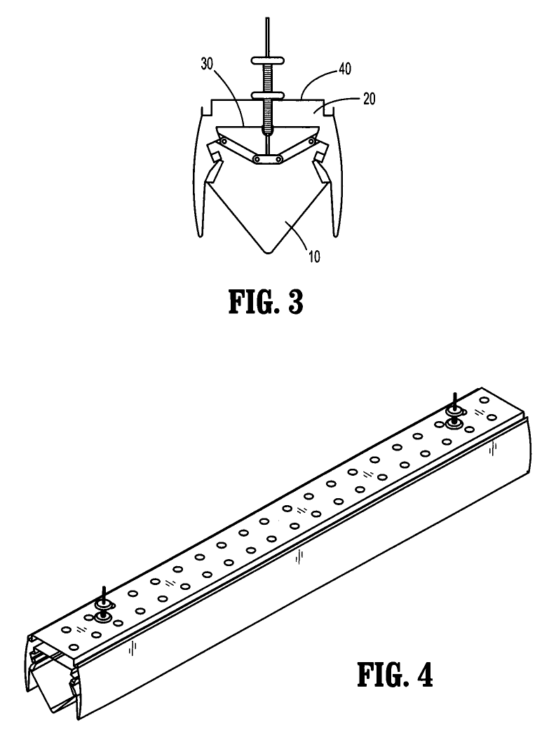

FIG. 3: a cross-sectional view of the apparatus in accordance with the invention in a second position/shape of the first partition wall;

FIG. 4: a perspective representation of the apparatus in accordance with FIG. 3;

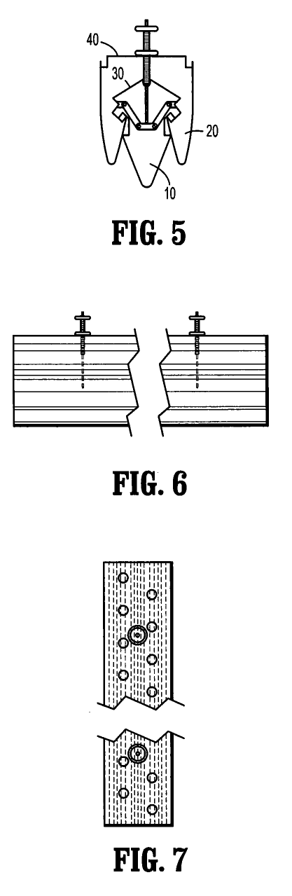

FIG. 5: a cross-sectional view of the apparatus in accordance with the invention in a third position/shape of the first partition wall;

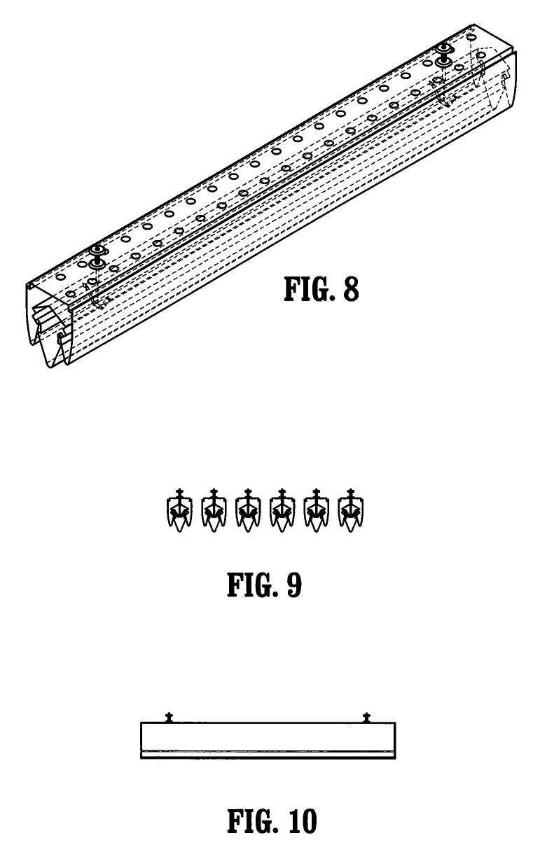

FIGS. 6-8: different representations of the apparatus in accordance with FIG. 5;

FIGS. 9-13: different representations of a plurality of apparatus arranged next to one another; and

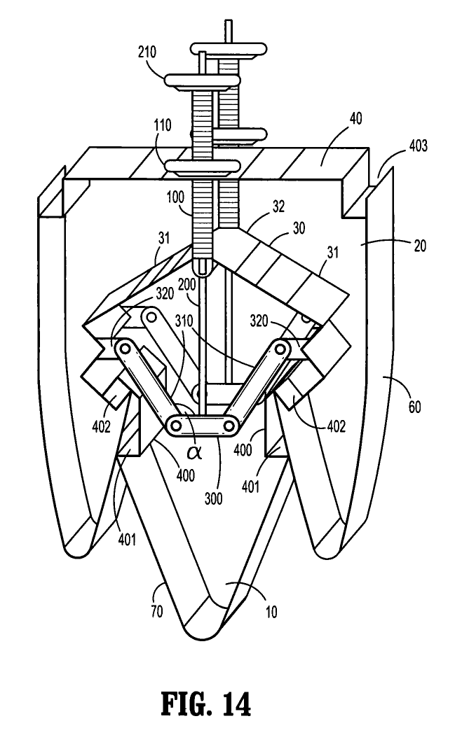

FIG. 14: a further cross-sectional view of the apparatus in accordance with the invention in a third position/shape of the first partition wall.

The design of an embodiment of the apparatus in accordance with the invention will first be explained with reference to FIG. 14:

The apparatus has at least one first chamber 10 and at least one second chamber 20. In this respect, the first chamber 10 is separated from the second chamber 20 by a first partition wall 30. A further separation between the first chamber 10 and the second chamber 20 is achieved by the connection element 400 which can comprise steel.

As can further be seen from FIG. 14, the connection element 400 has a first groove-shaped receiver 401 and a second groove-shaped receiver 402 spaced apart therefrom. These receivers 401, 402 are arranged in the upper and lower end regions of the connection element 400. They are made U-shape in cross-section. The receivers 401, 402 are connected to one another by a section of the connection element 400 or they form the upper and lower marginal regions of the connection element 400. The length of the connection element 400, which can be designed as a rail, preferably corresponds to that of the total apparatus.

Two first walls are designated by the reference numeral 60 and a second wall is designated by the reference numeral 70. As can be seen from FIG. 14, the first walls 60 form the side outer walls and the base of the second chamber 20 and the second wall 70 forms the side outer wall and the base of the first chamber 10.

Openings, not shown in any more detail in FIG. 14, are located in the first partition wall 30 which are spaced apart from one another in the longitudinal direction of the apparatus and which serve the reception of a container or other holder for fixing a plant, likewise not shown.

The upper boundary of the apparatus is formed by the second partition wall 40 which extends substantially horizontally in the embodiment or has a horizontally extending section. This second partition wall 40 has in its two marginal regions reception regions 403 which are formed in U shape in cross-section in the example shown here.

The upper end region of the first wall 60 is located in this U-shaped reception region 403. An inlay or the like can furthermore be located in the reception region 403 and applies weight to and/or fixes the marginal region of the first wall 60 in the reception region 403. It is conceivable to wind the first wall 60 once or a multiple of times around the element to obtain a particularly reliable fixing. If the first wall 60 should be removed, for example to remove the crop from the second chamber 20, it can be removed from the reception region 403 and moved away downwardly or pivoted downwardly so that the second chamber 20 is accessible from the side.

This does not only apply to the right wall 60 shown in FIG. 14, but also in a corresponding manner to the left wall 60.

The first wall 60 and/or the second wall 70 preferably comprises a flexible material such as plastic. It can be made as a film which can be wound up or is wound up so that the height of the first wall 60 can easily be changed. Independently of whether the inlay is present in the receiver 403 or not, the first wall 60 can be received in multiple layers in the receiver 403 such that its height can be changed in accordance with FIG. 14 in that more or less material of the wall 60 is positioned in the receiver 403. This applies correspondingly to the further receivers 60 and/or to the second wall 70.

The second side wall 70 can likewise comprise a flexible or also a rigid material. As can be seen from FIG. 14, the second wall 70 is connected at both sides in its upper end regions to the receiver 401 of the connection element 400. An inlay or the like can also be arranged there which holds the region of the second wall 70 in the receiver 401. It is conceivable that the region of the second wall is wound up once or a multiple of times around this inlay to achieve a particularly stable fixing of the second wall 70 in the receiver 401. If the second wall 70 should be removed, it is released from the connection element 400 or is removed from the receiver 401 so that after the corresponding pivoting or after the complete removal of the second wall 70, the first chamber 10 is then accessible.

This fixing of the second wall 70 takes place, as in FIG. 14, at both sides, i.e. two connection elements 400 are provided of which a respective one holds a margin of the second wall 70.

As stated above, the connection element 400 has a further reception region 402 which fixes the other marginal region of the first wall 60, i.e. the marginal region which is not already fixed in the receiver 403. The fixing of the marginal region of the first wall 60 in the receiver 402 can take place analog to the fixing of the second wall 70 in the receiver 401, that is with or without the aid of one or more inlays or the like which can be received in the receivers 401, 402, 403. The wall 60 can be received in one layer or in a multiple of layers in the receiver 402 so that, alternatively or additionally to the receiver 403, a rolling up or off or a winding up or off is possible.

Independently of whether one or more inlays are provided, provision is generally preferably made that the first wall 60 is connected to the second partition wall 40 and/or to the connection element 400 and/or that the second wall 70 is releasably connected to the connection element 400.

The connection element 400 is connected in the region 402 to the lower end region of the first partition wall 40 which can be U-shaped in cross-section. It is thus possible to hook the section of the connection element 400 having the reception region 402 to the first partition wall. The two mutually connected sections of the first partition wall 40, on the one hand, and of the connection element 400, on the other hand, can bound a space in which the marginal region of the first wall 60 or the above-named inlay are located.

The first chamber 10 of the apparatus is thus formed or bounded by the first partition wall 30, the connection element 400 and the second side wall 70. The second chamber 20 is formed or bounded by the first partition wall 30, the connection element 400, the first wall 60 and the second partition wall 40.

The first partition wall 30 comprises at least two sections of less flexibility 31 which can, for example, comprise steel and at least one section 32 of greater flexibility which connects them and which can comprise rubber, for example.

This section 32 is fixedly or releasable connected to a first bar 100 which has an external thread and which extends through an opening in the second partition wall 40. A hand wheel 110 is located in the region of this opening and has an internal thread which meshes with the external thread of the first bar 100. The hand wheel 110 is rotatably arranged or fixed at the second partition wall 40.

If the hand wheel 110 is rotated, this has the result that the first bar 100, which can be arranged rotationally fixedly, is moved upwardly or downwardly depending on the direction of rotation.

This movement of the first bar 100 results, due to the connection of the first bar 100 to the first partition wall 30, in a corresponding upward or downward movement of the first partition wall 30, which results in an increase or decrease in the first chamber 10 and/or in the second chamber 20.

The first bar 100 is hollow. A second bar 200 which is likewise designed with an external thread extends through said first bar. This second bar 200 is fixedly or releasably connected to a lever 300. The movement in translation of the second bar 200 takes place analog to that of the first bar 100.

A further hand wheel 210 is provided for actuating the second bar 200 and has a threaded bore whose thread is in engagement with the external thread of the second bar 200. Due to the fact that the outer diameter of the first bar 100 is larger than that of the second bar 200, the threaded bore of the hand wheel 110 is larger than that of the hand wheel 210.

The hand wheel 210 can be arranged fixedly or releasably, but in any case rotatably, in the upper end region of the first bar 100.

The lever 300 is pivotably connected to two levers 310 which are in turn pivotably connected to lugs 320 which extend from the first partition wall 100 into the first chamber 10.

If the hand wheel 210 is rotated, this results in an upward or downward movement of the second bar 200 and thus in an upward or downward movement of the lever 300 as well as in a change in the angle α between the lever 300 and the lever 310. If, starting from the position in accordance with FIG. 14, the second bar 200 is moved upwardly, the angle α is increased, which has the result that the extent of the total lever mechanism comprising the lever 300 and the levers 310 is increased in the width direction in accordance with FIG. 14. This in turn has the consequence that the inclination of the sections 31 is reduced, starting from the position in accordance with FIG. 14.

Depending on the arrangement of the apparatus, it is conceivable that a position is reached by the upward movement of the second bar 200 in which the sections 31 of the first partition wall 30 extend horizontally or are even inclined toward the second bar 200.

It is thus possible to achieve a change in the inclination of the first partition wall 30 or of its sections 21 by actuating the hand wheel 210.

Instead of the arrangement shown including rotatable hand wheels and rotationally fixed bars, an embodiment is naturally likewise conceivable in which the hand wheels or nuts or the like are not rotatable and a movement in translation of the bars is achieved in that the bars are rotated.

FIG. 1 shows the arrangement in accordance with FIG. 14 in a first growth stage of the plant, wherein reference numerals have been completely or predominantly omitted in this Figure as well as in the further Figures for better clarity. In this stage, the first bar 100 is moved comparatively far upwardly. i.e. the spacing between the first partition wall 30 and the second partition wall 40 is relatively small. The second chamber 20 is comparatively small and the first partition wall 30 is horizontal.

FIG. 2 shows a perspective view of this apparatus. It becomes clear from FIG. 2 that the apparatus has an elongate extent and has two adjustment apparatus spaced apart from one another which are described with respect to FIG. 14. The openings 42 of the second partition wall 40 can furthermore be seen from FIG. 2 through which the stems or the like of the plants extend. The region of the plants bearing the leaves is preferably located above the partition wall 40. As can further be seen from FIG. 2, the outlet openings 42 of the second partition wall 40 are spaced apart from one another in the longitudinal direction of the apparatus, with this spacing being able to take place regularly or irregularly. The same applies accordingly to openings in the first partition wall 30 which can be arranged offset to the openings 42 or can be aligned with them.

A plurality of containers for receiving plants or seedlings are preferably located in the first partition wall 30 or in its named openings.

The region of a crop plant, not shown, is located above the container or in the region of the second chamber 20 in which region preferably the crop and/or offshoots, stolons, air roots, etc. such as crops, for example potatoes or the like, grow. In particular the root region of the plant is located beneath the container, i.e. in the first chamber 10. The region of the plant which bears the leaves is located above the second partition wall 40 which is provided with outlet openings 42.

Means for supplying water, nutrients, etc. are preferably located in the first chamber 10. When the apparatus is in use, water or an air/water mixture or moistened air and/or air enriched with nutrients or a mixture of nutrients and/or water and/or air are thus, for example, located in the first chamber 10. Air is preferably located in the second chamber 20. Here, too, however, a moistening or a supply of nutrients is conceivable, for which purpose means can be provided which are not shown in the drawing.

The region 20 can be selected as relatively small in a young or early growth stage since fruit or crop is not yet present at the plant. This is shown in FIG. 1.

In the course of the development of the crop, the first partition wall 30 can be manually or automatically moved downwardly or can be pivoted by the described adjustment mechanism, namely by the bar 100 and the hand wheel 110, so that an enlargement of the second chamber 20 results. The first partition wall 30 can be designed so that, after a movement into a different position, it maintains this position and does not spring back.

This position of the first partition wall 30 is shown in FIG. 3. It furthermore results from the perspective representation in accordance with FIG. 4. As can be seen from FIG. 3, the first partition wall 30 is moved downwardly with respect to the position in accordance with FIG. 1, whereby an enlargement of the volume of the second chamber 20 results. The volume of the first chamber 10 has not changed thereby since the first walls 60 have undergone an extension, which is possible in that they are themselves preferably elastically deformable and/or in that they were unrolled from the reception region 402 and/or 403.

It is generally possible within the framework of the invention to increase or decrease the second chamber 20 without this resulting in a change in the size of the first chamber 10. Provision can conversely be made to increase or decrease the first chamber 10 without this resulting in a change in the size of the second chamber 20.

If now, starting from the position in accordance with FIG. 3, the inclination of the sections 31 of the first partition wall 30 should be changed, the second bar 200 is moved downwardly, which has the result that the sections 31 are inclined away from the second bar 200, as can be seen from FIGS. 5 and 14. This inclination has the result that the crop slides off from the sections 31 or has the tendency to move from the sections 31 into the region of the second chamber 20, said region being located next to the first partition wall 30 or next to the connection element 400, and optionally into the lower region of the second chamber 20 which, in accordance with FIG. 14, forms the base of the second chamber 20.

FIGS. 6-8 show the arrangement in accordance with FIG. 5 in a side view, in a plan view and in a perspective view.

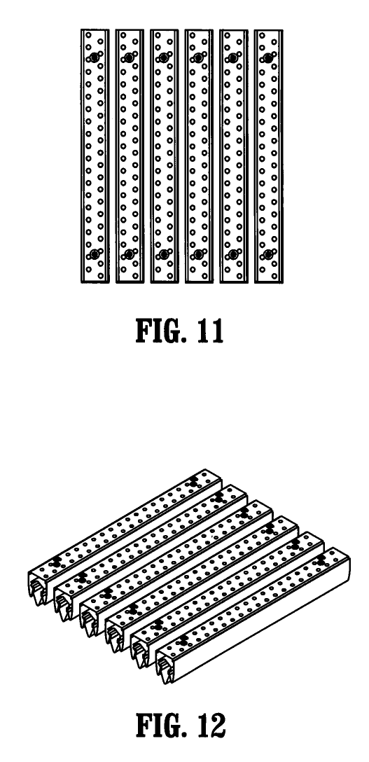

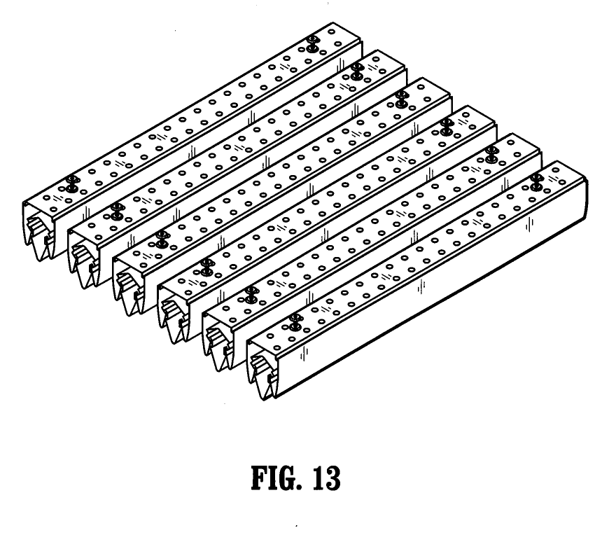

A plurality of the apparatus in accordance with the present invention can naturally be combined to form a group. An arrangement of a plurality of apparatus located next to one another can be seen from FIG. 9. FIG. 10 shows this arrangement in a side view; FIG. 11 in a plan view; and FIGS. 12 and 13 in perspective views.

It is conceivable to arrange the plurality of apparatus arranged next to one another displaceably such that the spacing between two adjacent apparatus can be changed for harvesting purposes or for other purposes.

1. An apparatus for cultivating one or more plants comprising at least one first chamber and at least one second chamber which are separated from one another by at least one first partition wall, wherein the inner spaces of the first and second chambers communicate by one or more communication openings in the first partition wall, and wherein the apparatus has at least one adjustment device which is arranged and designed so that a change in the position and/or a change in the shape of the first partition wall takes place on an actuation of the adjustment device.

2. An apparatus in accordance with claim 1, wherein the adjustment device is directly connected to the first partition wall.

3. An apparatus in accordance with claim 1, wherein the adjustment device is designed such that on its actuation, the first partition wall is moved so that the size of the first chamber and/or of the second chamber changes due to the movement of the first partition wall.

4. An apparatus in accordance with claim 1, wherein the adjustment device has a first adjustment mechanism which is directly or indirectly connected to the first partition wall such that on an actuation of the first adjustment mechanism, the position of the first partition wall changes.

5. An apparatus in accordance with claim 4, wherein the first adjustment mechanism has a first bar, preferably a threaded bar or the like, which is directly or indirectly connected to the first partition wall.

6. An apparatus in accordance with claim 5, wherein the first adjustment mechanism has an actuation element, preferably an actuation element having an internal thread which is connected to the first bar such that, on a rotation of the actuation element, a movement in translation of the first bar takes place.

7. An apparatus in accordance with claim 1, wherein the first partition wall is deformable section-wise or completely.

8. An apparatus in accordance with claim 1, wherein the first partition wall has at least two sections whose angle toward one another is changeable.

9. An apparatus in accordance with claim 1, wherein the adjustment device has a second adjustment mechanism which is directly or indirectly connected to the first partition wall such that on an actuation of the second adjustment mechanism, the shape of the first partition wall changes.

10. An apparatus in accordance with claim 9, wherein the second adjustment mechanism has a second bar, preferably a threaded bar or the like, which is directly or indirectly connected to the first partition wall.

11. An apparatus in accordance with claim 10, wherein the second adjustment mechanism has an actuation element, preferably an actuation element having an internal thread which is connected to the second bar such that, on a rotation of the actuation element, a movement in translation of the second bar takes place.

12. An apparatus in accordance with claim 9, wherein the second adjustment mechanism has at least one lever mechanism.

13. An apparatus in accordance with claim 12, wherein the lever mechanism has at least one first lever which is directly or indirectly connected to the second bar and/or at least one second lever which is directly or indirectly connected to the first partition wall, with provision preferably being made that the first lever is pivotably connected to the second lever; and/or that the second lever is pivotably connected to the first partition wall.

14. An apparatus in accordance with claim 10, wherein the first bar is hollow; and in that the second bar runs at least section-wise in the hollow space of the first bar.

15. An apparatus in accordance with claim 1, wherein the adjustment device is arranged such that its actuation is possible from outside the first chamber and the second chamber.

16. An apparatus in accordance with claim 1, wherein the second chamber has one or more outlet opening(s) which is/are arranged in at least one second partition wall which bounds the second chamber at least regionally, preferably at its upper side.

17. An apparatus in accordance with claim 1, wherein the apparatus has at least one first wall and/or at least one second wall which comprises a flexible material and/or whose height and/or length and/or width is changeable.

18. An apparatus in accordance with claim 1, wherein the apparatus has at least one first wall, preferably a side wall, which forms a boundary of the second chamber.

19. An apparatus in accordance with claim 1, wherein the apparatus has at least one second wall, preferably a side wall, which forms a boundary of the first chamber.

20. An apparatus in accordance with claim 19, wherein the first wall and/or the second wall is flexible and preferably consists of or comprises plastic.

21. An apparatus in accordance with claim 19, wherein the first wall and the second wall are directly or indirectly connected to one another.

22. An apparatus in accordance with claim 21, wherein at least one connection element is provided which connects the first wall to the second wall.

23. An apparatus in accordance with claim 22, wherein the connection element and/or the first partition wall has at least one receiver in which a region of the first wall and/or a region of the second wall is received, with provision preferably being made that at least one element is arranged in the at least one receiver which fixes the region of the first wall and/or of the second wall in the receiver.

24. An apparatus in accordance with claim 16, wherein the second partition wall has at least one receiver in which a region of the first wall is received, with provision preferably being made that at least one element is arranged in the at least one receiver which fixes the region of the first wall in the receiver.

25. An apparatus in accordance with claim 1, wherein at least one plant is arranged in the apparatus such that the roots of the plant are located exclusively or predominantly in the first chamber and the region of the plant bearing the crop is located exclusively or predominantly in the second chamber.

26. An apparatus in accordance with claim 1, wherein at least one plant is arranged in the apparatus such that at least one container or holder for fixing the plant is located in the at least one communication opening of the first partition wall.

27. An apparatus in accordance with claim 16, wherein at least one plant is arranged in the apparatus such that the stem of the plant extends through the at least one outlet opening of the second partition wall and the leaves of the plant are located at least in part above the second partition wall and outside the second chamber.

28. An apparatus in accordance with claim 1, wherein water and/or nutrients are present in the first chamber and/or in the second chamber; and/or in that means are provided by means of which water and/or nutrients can be supplied to the first chamber and/or to the second chamber.

29. An apparatus in accordance with claim 1, wherein the second chamber extends at least regionally above and/or next to the first chamber.

30. An apparatus in accordance with claim 1, wherein the apparatus has an elongate extent and/or is formed as rectangular, square or trough-shaped in cross-section.

31. An arrangement including a plurality of apparatus for cultivating one or more plants, in accordance with claim 1, wherein provision is preferably made that the apparatus are arranged such that their distance from one another is changeable.

32. An arrangement in accordance with claim 31, wherein the apparatus form rows or are arranged in rows, with the spacing of the rows from one another being changeable.

33. An arrangement in accordance with claim 32, wherein the apparatus are connected to a suspension, wherein the suspension is designed so that the spacing of the apparatus or of the rows from one another is changeable; and/or in that the apparatus are connected to a support structure, in particular to rollers, rails, guides or the like, which are designed such that the spacing of the apparatus or of the rows from one another is changeable.

34. A method of cultivating one or more plants in an apparatus in accordance with claim 1, comprising the step-wise or continuous enlargement of the volume and/or shape of the second chamber.

35. A method in accordance with claim 34, wherein the enlargement of the volume and/or of the shape of the second chamber takes place by changing the position and/or the shape of the first partition wall by means of the adjustment device.

36. A method of harvesting the crop of one or more plants in an apparatus in accordance with claim 1, comprising the step of the at least sectional pivoting, displacing or removing of at least one boundary surface of the second chamber and the removal of the crop from the second chamber, wherein this step is preferably preceded by the enlargement of the spacing of at least two of the apparatus.
